(19) United States
(12) Patent Application Publication
(10) Pub. No.: US 2007/0077915 A1
(43) Pub. Date: Apr. 5, 2007

(54) Method and apparatus for module authentication

(76) Inventors: Greg R. Black, Vernon Hills, IL (US); Joel A. Clark, Woodbridge, IL (US); Kent D. Rager, Gurnee, IL (US)

Correspondence Address: INGRASSIA FISHER & LORENZ, P.C., 7150 E. CAMELBACK, STE. 325, SCOTTSDALE, AZ, 85251, US

(21) Appl. No.: 11/240,656

(22) Filed: Sep. 30, 2005

(51) Int. Cl. H04M 1/66

(52) U.S. Cl. 455/411

(57) ABSTRACT

A method and apparatus for modular authentication of a wireless communication device (120) including a portable communication device (210) and a wireless communication module (220) coupleable thereto is disclosed. When the wireless communication module (220) receives information (706) from the portable communication device (210), it determines whether the information received is authentic information (710) and operates together with the portable communication device (210) as a wireless communication device (120) in a communication system (100) in response to the information received being authentic information (720). In addition, a method and apparatus is disclosed for checking subsidy lock in a wireless communication device (120) capable of operating in a communication system (100), the wireless communication device comprising a first module (210), a second module (220) and a subscriber identity module (230) coupled to the first and second modules (210, 220). The first and second modules (210, 220) independently determine whether subsidy lock information stored in the subscriber identity module (230) corresponds to correct subsidy lock information (614, 618), and set a state of the wireless communication device (120) as operable in the communication system (100) in response to determining that the subsidy lock information stored in the subscriber identity module (230) corresponds to the correct subsidy lock information (614, 618).

### FIELD OF THE INVENTION

The present invention generally relates to portable communication devices, and more particularly relates to a method and apparatus for authenticating modules of a modular portable communication device.

### BACKGROUND OF THE INVENTION

Over the course of a product's life cycle, a device is subject to many changes in the product's features. In addition, a product family may offer many different features to distinguish high-cost models from low-cost models. Portable communication devices, such as cellular phones, are experiencing this pressure to provide distinguishable models in product families as well as to provide different and more features in some or all models.

Having different models with different functionalities makes it difficult to offer low cost models because each different model may require a different design and different manufacturing. Offering a number of low cost models with different functionalities and features is also difficult because of the scalability issue. For example, today's portable communication devices may require differing user interfaces and/or differing displays and display drivers. In addition, higher functionality portable communication devices, such as many portable communication devices, may require increased signaling computationability, while lower functionality portable communication devices require less signaling computationability. Having many different model portable communication devices is less scalable in that changing out displays or user interfaces may require printed circuit board modifications. In addition, while signaling computation can be facilitated by, for example, baseband memory and the least expensive solution is a read-only memory (ROM) baseband memory, expensive memory, such as flash memory, is required to facilitate firmware changes. One solution is to provide a plurality of modules, which together make up the portable communication device, where each module is manufactured separately.

The benefit of modular portable communication devices is also a drawback—one module may work with a number of other modules. The manufacturer wants to maintain control over modular interoperability to limit the time-to-market burden and expense of obtaining regulatory approvals for all combinations of modules. Another reason for the manufacturer to maintain control over interoperability is to prevent end users from purchasing a low cost device and upgrading it by replacing modules. For example, one method of achieving low cost for the end-user is for the manufacturer to enter into a subsidy lock agreement with a network operator. In a subsidy lock agreement, the network operator discounts the price of an electronic device to the end user in exchange for agreement to a limitation that the device is exclusively operable with a SIM card from the subsidizing operator. Thus, it is important that a modular device employing subsidy lock will continue to be exclusively operable with a SIM card from the subsidizing operator after modules have been replaced.

Thus, what is needed is a method and apparatus for authenticating one module with another prior to allowing interoperability therebetween. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements.

FIG. 1 is a diagram of a communication system in accordance with an embodiment of the present invention;

FIG. 2 is a breakaway view of a combination portable communication device and wireless communication module in accordance with an embodiment of the present invention;

FIG. 3 is a side view of the combination portable communication device and wireless communication module in accordance with an embodiment of the present invention;

FIG. 4 is a block diagram of the portable communication device of FIG. 3 in accordance with the embodiment of the present invention;

FIG. 5 is a block diagram of the wireless communication module of FIG. 3 in accordance with the embodiment of the present invention;

FIG. 6 is a high level flowchart of the authentication procedure of the wireless communication device of FIG. 2 in accordance with the embodiment of the present invention;

FIG. 7 is a more detailed flowchart of the authentication procedure of the portable communication device of FIG. 4 in accordance with the embodiment of the present invention; and

FIG. 8 is a more detailed flowchart of the authentication procedure of the communication module of FIG. 5 in accordance with the embodiment of the present invention.

### DETAILED DESCRIPTION OF THE INVENTION

A method and apparatus for modular authentication of a wireless communication device including a portable communication device and a wireless communication module coupleable thereto is disclosed. When the wireless communication module receives information from the portable communication device, it determines whether the information received therefrom is authentic information. The wireless communication module operates together with the portable communication device as a wireless communication device in a communication system in response to the information received being authentic information. In addition, a method and apparatus is disclosed for checking subsidy lock in a wireless communication device capable of operating in a communication system, the wireless communication device comprising a first module, a second module and a subscriber identity module coupled to the first and second modules. The first and second modules independently determine whether subsidy lock information stored in the subscriber identity module corresponds to correct subsidy lock information, and set a state of the wireless communication device as operable in the communication system in response to the first module and the second module both determining that the subsidy lock information stored in the subscriber identity module corresponds to the correct subsidy lock information.

The following detailed description of the invention is merely exemplary in nature and is not intended to limit the invention or the application and uses of the invention. Furthermore, there is no intention to be bound by any theory presented in the preceding background of the invention or the following detailed description of the invention.

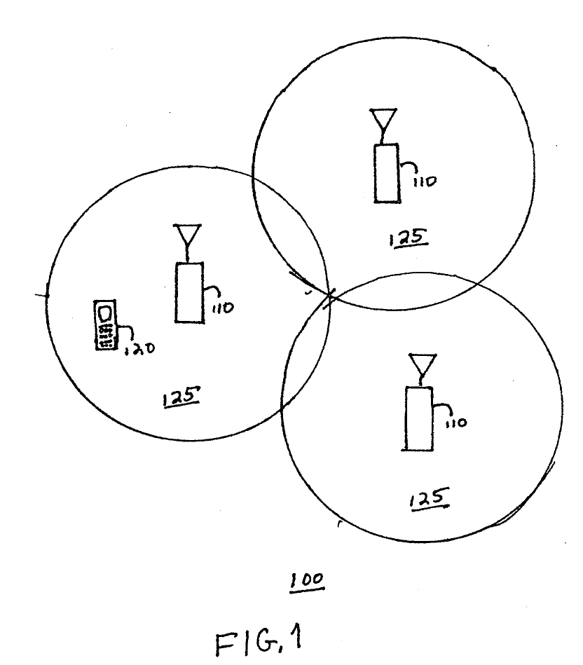

Referring to FIG. 1, a communication system 100 in accordance with an embodiment of the present invention includes a plurality of base stations 110 and a wireless communication device 120. The communication system has public land mobile network (PLMN) information associated therewith and the wireless communication device 120, if having appropriate PLMN information associated therewith, communicates in the communication system 100 by communicating with the plurality of base stations 110 on one or more of a plurality of channels. Associated with each of the plurality of base stations 110 is a coverage area 125 wherein the wireless communication device 120 can receive signals from and transmit signals to such one of the plurality of base stations 110 on any of the plurality of channels.

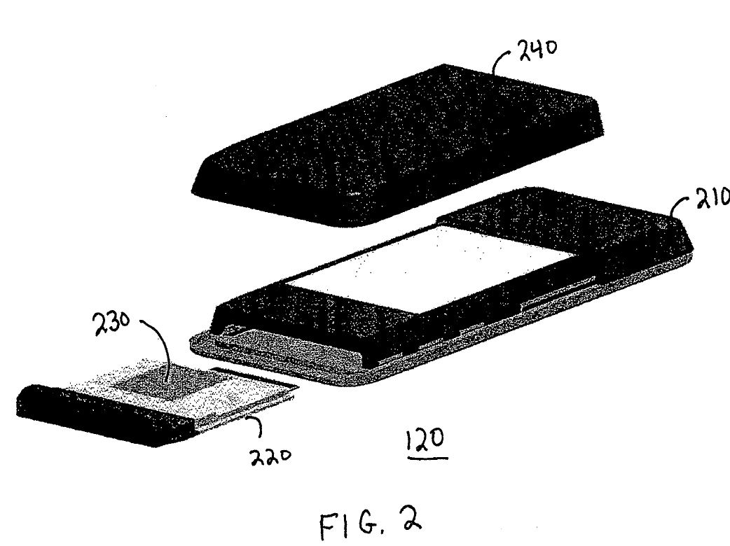

Referring to FIG. 2, a breakaway view from a bottom right rear angle of the wireless communication device 120 showing assembly thereof is depicted. The wireless communication device 120 includes a first module 210 and a second module 220. The first module 210 is a portable communication device or, more specifically, a portable communication handset. The second module 220 is a wireless communication module, such as a wireless communication modem, for coupling to the portable communication device 210 to operate together as a wireless communication device 120.

A subscriber identity module (SIM) 230 couples to the wireless communication modem 220 for permitting operation of the wireless communication device 120 in the communication system 100 as described hereinbelow. After the portable communication handset 210 and the wireless communication modem 220 are coupled together, the rear case 240 is connected to complete manufacturer's assembly for enclosing both modules together into one wireless communication device 120.

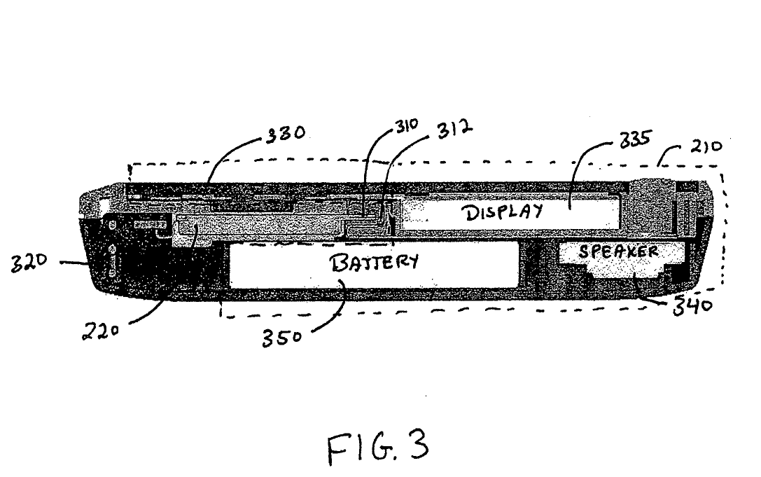

The side planar view of FIG. 3 shows the completed wireless communication device 120. The wireless communication modem 220 has a module coupler 310 for physically and electrically coupling the wireless communication modem 220 to a coupler 312 of the portable communication handset 210. The wireless communication modem 220 also has an antenna 320 connected thereto for transmission of signals to and reception of signals from the base stations 110 (FIG. 1). User interface devices coupled to the portable communication handset 210 include a telephonic numeric keypad 330, a display 335 and a speaker 340. A battery 350 is also coupled to the portable communication handset 210 for provision of power to the portable communication handset 210 and the wireless communication modem 220.

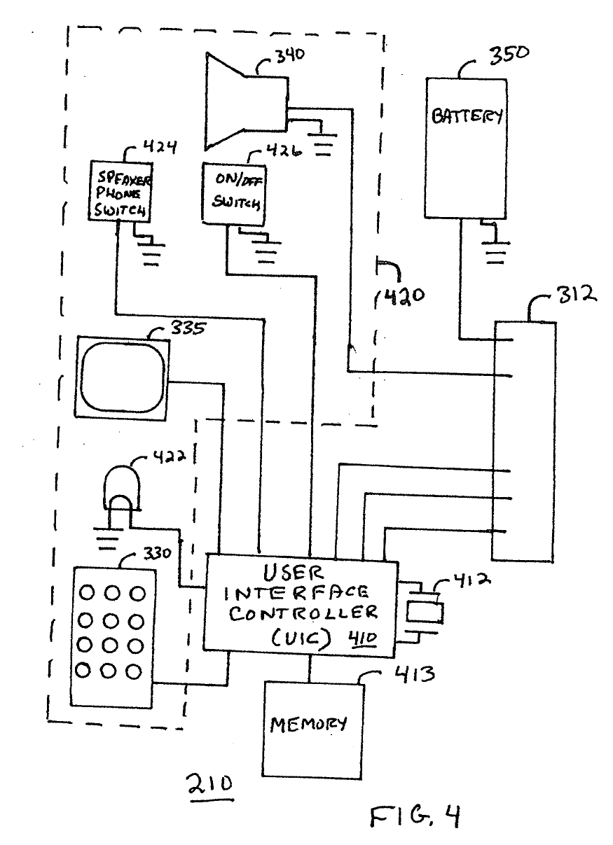

Referring to FIG. 4, a block diagram of the portable communication handset 210 includes a user interface controller 410 coupled to a clock 412 to provide clocking signals for operation of the controller 410 and a memory 413 storing information for the operation of the user interface controller 410. The controller 410 is coupled to user interface devices 420 which include the telephonic numeric keypad 330, the display 335, the speaker 340 and a light 422, such as a backlight for the display 335. The user interface devices 420 also include switches such as a switch 424 for activating speaker phone capability if the wireless communication device 120 permits speaker phone operation and a switch 426 for turning the wireless communication device 120 on or off (i.e., for providing operational information setting a state of the wireless communication device 120 as operable or as inoperable).

The coupler 312, which physically and electrically couples the portable communication handset 210 to the wireless communication modem 220, is coupled to the controller 410 for receiving signals therefrom and providing signals thereto. The speaker 340, while physically mounted in the portable communication handset 210, is coupled to the coupler 312 for receiving operational signals from the wireless communication modem 220 for alerting the user such as ringing tones. The battery 350 also is coupled to the coupler 312 for providing power to the wireless communication device 120. While in the embodiment described herein, the user interface devices 420 are coupled to the user interface controller 410, one or more of the user interface devices 420 (e.g., the keypad 330, the display 335, or the switches 424, 426) could be resident in the handset yet coupled to the coupler 312 for providing signals directly to or receiving operational signals directly from the wireless communication modem 220. Alternatively, either of the switches 424, 426 or the keypad 330 could be on the wireless communication modem 220.

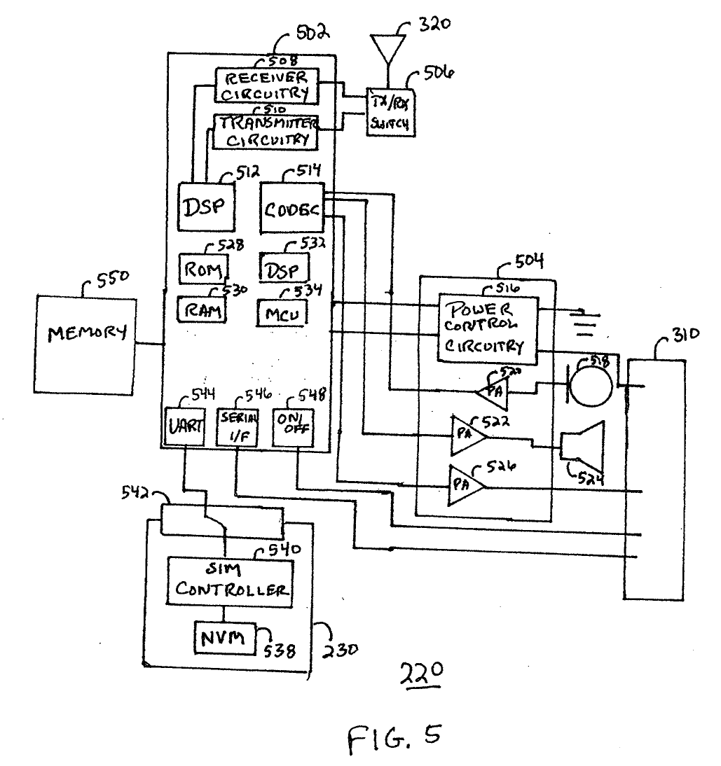

Referring to FIG. 5, the wireless communication modem 220 includes a transceiver baseband controller 502 and a power management integrated circuit (IC) 504. The antenna 320 receives and transmits radio frequency (RF) signals and is coupled to a receive/transmit switch 506. The receive/transmit switch 506 selectively couples the antenna 320 to receiver circuitry 508 and transmitter circuitry 510 in the baseband controller 502 in a manner familiar to those skilled in the art. The receiver circuitry 508 demodulates and decodes the RF signals to derive information and is coupled to a peripheral digital signal processor (DSP) 512 for providing the decoded information thereto for utilization thereby in accordance with the function(s) of the wireless communication device 120. The DSP 512 also provides information to the transmitter circuitry 510 for encoding and modulating information into RF signals for transmission from the antenna 320

A codec 514 provides signals to power control circuitry 516 on the power management IC 504 which provides power from the battery 350 coupled through the coupler 310 to the circuits and devices of the portable communication handset 210 and the wireless communication module 220 for operation of the wireless communication device 120. For communication on the wireless communication device 110, the codec 514 receives signals from a microphone 518 amplified by a power amplifier 520 and provides signals to a power amplifier 522 for powering a speaker 524. In addition, the codec 514 provides alert signals to a power amplifier 526 which is coupled to the speaker 340 through the coupler 310. Though depicted in the present embodiment as part of the transceiver baseband controller 502, the codec 514 could alternatively reside in the portable communication handset 210 for operation of the speaker 340 therein.

The subscriber identity module (SIM card) 230 includes a SIM controller 538 and a SIM non-volatile memory (NVM) 540. The SIM controller 538 is connected to a SIM coupler 542 for physically and electrically coupling the SIM card 230 to the wireless communication module 220. The SIM card 230 could, on the other hand, be coupled to the portable communication handset 210 through coupler 542. As is known to those skilled in the art, the SIM NVM stores subsidy lock information which includes an International Mobile Subscriber Identity (IMSI) and optionally group identifier 1 and 2 information (GID1 and GID2). Contained within the IMSI value is the home public land mobile network (HPLMN) information designating the PLMN communication system 100 to which the user has subscribed for service. The wireless communication device 110 is authorized to operate in this. HPLMN as well as in any other PLMN with which the HPLMN has roaming agreements.

As is also known to those skilled in the art, the transceiver baseband controller includes a read only memory (ROM) 528, a random access memory (RAM) 530, a DSP 532 and a microcontroller unit (MCU) 524. A SIM universal asynchronous receiver/transmitter (SIM UART) 544 coupled to the SIM controller 540 through the SIM coupler 542, a serial I/F device 546 coupled to the user interface controller 410 through the coupler 310 and the module coupler 312, and a on_off/general purpose input_output (GPIO) 548 also coupled to the user interface controller 410 through the coupler 310 and the module coupler 312 (alternatively, the on_off block could be directly coupled to the on_off switch 426). A memory 550 is coupled to the transceiver baseband IC 502 for storing information used for the operation of the wireless communication device 120.

Thus it can be seen that the present invention allows a single wireless communication module 220 to provide RF and audio modem functions over a range of products having differing transducer capabilities. This is achieved by separation of the audio and RF functions into the wireless communication module 220 and the user interface functions into the portable communication handset 210. In another embodiment of the present invention, the wireless communication module 220 could be designed only for RF modem functions, with some or all of the audio apparati on the portable communication handset 210 side of the couplers 312, 310.

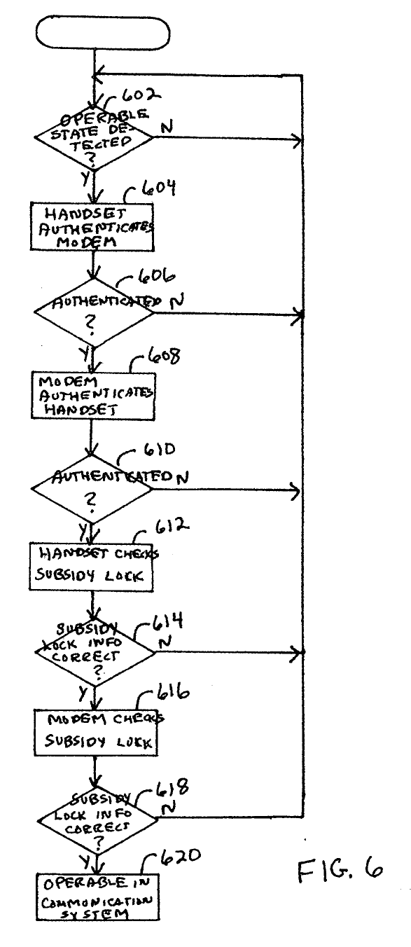

Referring to FIG. 6, a flowchart of the operation in accordance with the embodiment of the present invention begins with the wireless communication module determining whether operational information has been received from the user interface devices 420 indicating that the state of the wireless communication device 120 has been set as operable 602. Such operational information could be generated by a user switching the switch 426 from off to on. It could also be generated in response to detecting that the couplers 310 and 312 have been coupled together, coupling the portable communication handset 210 to the wireless communication modem 220. Or it could be generated by detection that the SIM card 230 has been coupled to the wireless communication device 120. On the other hand, the authentication procedure described hereafter may occur at one or more random times during operation of the wireless communication device 120 and may or may not require detection of any particular state of operableness initiate the authentication procedure.

When the operable state of the wireless communication device 120 has been detected 602, the portable communication handset 210 authenticates 604 the wireless communication modem 220. If the modem 220 is authenticated 606, the modem 220 then authenticates 608 the handset 210. If the handset 210 is authenticated processing continues to perform independent subsidy lock checks by the handset 210 and the modem 220. It will be apparent to those skilled in the art that the order of following pairs of steps: 604 and 606; 608 and 610; 612 and 614; and 616 and 618; could be changed or the pairs of steps could occur simultaneously without departing from the spirit of the invention.

When the handset 210 is authenticated, the handset 210 checks the subsidy lock 612. If the subsidy lock information retrieved from the memory 538 of the SIM card 230 is the correct subsidy lock information 614 (i.e., the HPLMN information and optionally GID1/GID2 information stored in the memory 538 is equivalent to an allowed PLMN and GID1/GID2 information stored in the memory 413), then the modem checks the subsidy lock 616. If the subsidy lock information retrieved by the modem 210 is also correct subsidy lock information 618 (i.e., the HPLMN information and optionally GID1/GID2 information stored in the memory 538 is equivalent to an allowed PLMN and GID1/GID2 information stored in the memory 550), then the portable communication handset 210 operates 620 together with the wireless communication module 220 as a wireless communication device 120 in the communication system 100.

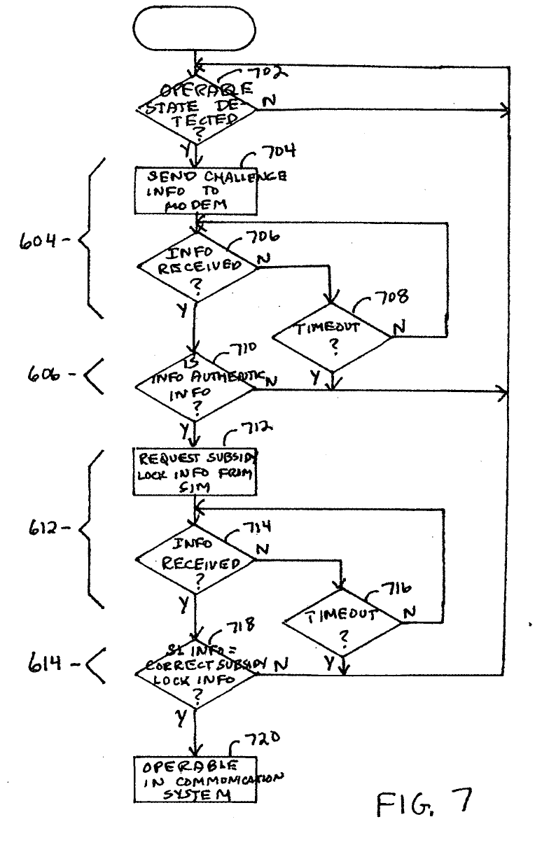

Referring to the flowchart of FIG. 7, the authentication and subsidy lock routine of the portable communication handset 210 is shown in some detail with reference to corresponding steps of FIG. 6 shown to the right of the flowchart. First, the handset 210 detects that operational information has been received that sets an operable state thereof 702. The handset 210 then sends a random challenge information 704 to the wireless communication modem 220. Processing checks to see whether information has been received 706 from the modem 220 or timeout has occurred 708 without receiving any such information 706. When information is received 706, it is determined whether the information is authentic information 710, by comparing with the challenge information encoded according to the coding method used by the modem.

In accordance with one aspect of the present invention, the information is determined to be authentic 710 in response to the information received from the modem and the challenge information sent to the modem. For example, in user interface controllers 410 with limited code and random access memory requirements, a first key could be stored in the memory 413 of the handset 210. The first key is universally the same to all of a set of handsets 210. A second key is stored in the memory 550 of the modem 220. This second key is a random key stored in the memory 550. Also stored in memory 550 is the value of the second key encrypted using the first key. The step of sending challenge information 704 includes the controller 410 retrieving the second key from the memory 550 by requesting the value of the second key encrypted by the first key from the controller 502. The controller 410 also generates a random number challenge which is sent to the controller 502. The MCU 534 of the modem 220 performs a known secure hash algorithm (SHA-1) on the random number, the second key and a fixed pattern and returns the hash digest to the controller 410. The controller 410 then determines if the hash digest (i.e., the information received from the modem 220) is authentic information by using the first key stored in memory 413 to decrypt the encrypted second key received, computing the same hash digest using the random number generated by the controller 410 and provided to the modem 220 as challenge information, the decrypted second key and the same fixed pattern. The hash digest thus created is compared to the hash digest received. If they are equivalent, information received from the modem 220 is authentic information 710.

After determining that the information received from the modem is authentic information 710, the controller 410 requests subsidy lock information 712 from the memory 538 of the subscriber identity module (SIM) 230. Processing next checks to see whether subsidy lock information has been received 714 from the SIM card 230 or timeout has occurred 716 without receiving any subsidy lock information 714. When subsidy lock information is received 714, the subsidy lock information is examined to determine if it is the correct subsidy lock information 718 for the communication system 100 by comparing it with the subsidy lock information stored in memory 413. If the subsidy lock information received from the SIM card 230 is found to be equivalent to the subsidy lock information stored in memory 413, then that information is found to be correct subsidy lock information 718 and the SIM card will be accepted by controller 410. The wireless communication device will then become operable 720 in accordance with the full processing of FIG. 6.

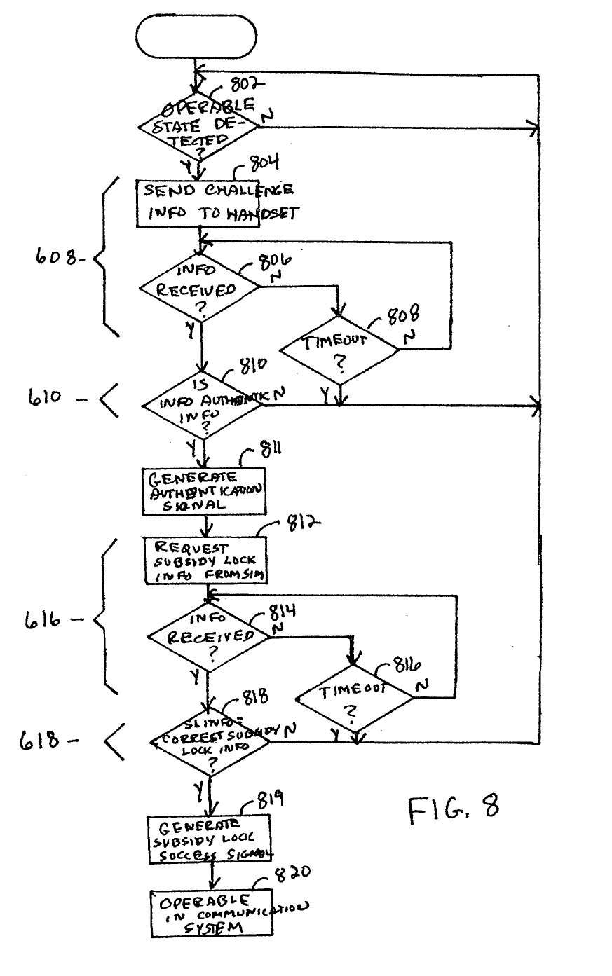

Referring next to the flowchart of FIG. 8, the authentication and subsidy lock routine of the wireless communication modem 220 is shown in some detail with reference to corresponding steps of FIG. 6 shown to the right of the flowchart. First, the modem 220 detects that operational information has been received that sets an operable state thereof 802. The modem 220 then sends random challenge information 804 to the portable communication handset 210. Processing checks to see whether information has been received 806 from the handset 210 or timeout has occurred 808 without receiving any such information 806. When information is received 806, it is determined whether the information is authentic information 810. If it is authentic information 810, the MCU 534 generates an authentication signal and provides the authentication signal 811 to the handset 210 indicating that the modem 220 has authenticated the handset 220. While this step 811 is shown here in FIG. 8, it could similarly occur in the flowchart of FIG. 7, depending on which authentication procedure 604, 608 (FIG. 6) is done first. Alternatively, if decision step 810 determines that the information is not authentic, the wireless communication modem could remain inoperative.

After determining that the information received from the handset 210 is authentic information 810 and generating the authentication signal 811, the MCU 534 requests subsidy lock information 812 from the memory 538 of the subscriber identity module (SIM) 230. Processing next checks to see whether subsidy lock information has been received 814 from the SIM card 230 or timeout has occurred 816 without receiving any subsidy lock information 814. When subsidy lock information is received 814, the subsidy lock information is examined to determine if it is correct subsidy lock information 818 by comparing it against subsidy lock information stored in memory 550. If the subsidy lock information from the SIM card 230 is equivalent to the subsidy lock information stored in memory 550, then the subsidy lock information is correct subsidy lock information 818 and the MCU 534 generates a subsidy lock success signal 819 and provides that signal to the handset 210. The wireless communication device 120 will then become operable 820 in accordance with the full processing of FIG. 6. While this step 819 is shown here in FIG. 8, it could, similar to step 811, occur in the flowchart of FIG. 7, depending on which authentication procedure 604, 608 (FIG. 6) is done first. If the subsidy lock information from the SIM card 230 is not equivalent to the subsidy lock information stored in memory 550, then the wireless communication modem could remain inoperative.

Thus, it can be seen that the present invention provides a modular assembly providing the flexibility to quickly adapt to shifting market requirements and offering a number of scalable wireless communication devices 120 without creating an opportunity for cloned devices to be created with mismatched modules. The modules mutually authenticate each other for both regulatory compliance and manufacturer's compliance. In addition, the modules independently check subsidy lock to verify that the wireless communication device 120 is authorized to use a SIM card 230 issued by the communication system 100. The embodiment described herein has control of the authentication routine residing in the user interface controller 410. While authentication of one module by the other and/or a single subsidy lock check may be sufficient to assure authorized operation of the wireless communication device 120, combination of requiring successful mutual authentication and independent subsidy lock achieves a greater degree of security.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. An authentication method in a portable communication device including user interface devices including a telephonic numeric keypad and having a wireless communication module coupleable thereto, the method comprising the steps of:
the portable communication device receiving information from the wireless communication module;
determining whether the information received from the wireless communication module is authentic information; and
the portable communication device operating together with the wireless communication module as a wireless communication device in a communication system in response to the information received being authentic information.

2. The method of claim 1 further comprising, before the step of receiving information from the wireless communication module, the step of the portable communication device receiving operational information from a user interface device setting a state thereof as operable.

3. The method of claim 1 further comprising, before the step of receiving information from the wireless communication module, the step of sending challenge information to the wireless communication module in response to receiving the operational information.

4. The method of claim 3 wherein the step of determining whether the information received is authentic information comprises the step of determining whether the information received is authentic information in response to the challenge information sent thereto and the information received therefrom.

5. The method of claim 1 further comprising the step of determining whether subsidy lock information stored in a subscriber identity module coupled to the portable communication device corresponds to correct subsidy lock information, and wherein the step of the portable communication device operating as a wireless communication device in the communication system comprises the step of the portable communication device operating as a wireless communication device in the communication system in response to the information received being authentic information and the subsidy lock information corresponding to correct subsidy lock information.

6. The method of claim 5 wherein the step of determining whether subsidy lock information corresponds to correct subsidy lock information comprises the step of determining whether subsidy lock information stored in a subscriber identity module coupled to the portable communication device corresponds to correct subsidy lock information stored in the wireless communication module.

7. The method of claim 5 wherein the step of determining whether subsidy lock information corresponds to correct subsidy lock information comprises the step of determining whether subsidy lock information stored in the subscriber identity module is equivalent to public land mobile network (PLMN) information designating a PLMN communication system, and wherein the step of the portable communication device operating as a wireless communication device comprises the step of the portable communication device operating as a wireless communication device in the PLMN communication system in response to the information received being authentic information and the subsidy lock information being equivalent to the PLMN information.

8. A portable communication device comprising:
user interface devices including a telephonic numeric keypad for receiving user input and generating input signals in response to the user input;
a module coupler for physically and electrically coupling a communication module to the portable communication device; and
a controller coupled to the user interface devices for receiving input signals therefrom and coupled to the module coupler for receiving signals from the communication module and for providing signals thereto, the controller determining whether information received from the communication module is authentic, and wherein the controller operates the portable communication device together with the communication module as a wireless communication device in response to the information from the communication module being authentic.

9. The portable communication device of claim 8 wherein the controller detects operable information from the user interface devices setting a state thereof as operable, and wherein the controller thereafter determines whether information received from the communication module is authentic.

10. The portable communication device of claim 8 wherein the controller is coupled to a subscriber identity module having a storage device for storing subsidy lock information and wherein the controller operates the portable communication device as a wireless communication device in response to the information from the communication module being authentic and the subsidy lock information corresponding to correct subsidy lock information.

11. The portable communication device of claim 8 further comprising a display for presenting information to a user, and wherein the controller provides signals for generating information to be displayed to the user to the display in response to information received from the communication module.

12. The portable communication device of claim 8 wherein the controller provides information for encoding and modulating into signals to be transmitted from the wireless communication device to the coupler for provision to a baseband controller within the communication module, and wherein the controller receives from the coupler information demodulated and decoded by the baseband controller from signals received by the wireless communication device.

13. An authentication method in a wireless communication module coupleable to a portable communication device having user interface devices, the method comprising the steps of:
the wireless communication module receiving information from the portable communication device;
determining whether the information received from the portable communication device is authentic; and
the wireless communication module operating together with the portable communication device as a wireless communication device in response to the information received being authentic.

14. The method of claim 13 further comprising, before the step of receiving information from the portable communication device, the wireless communication module receiving operational information from the user interface devices setting a state thereof as operable.

15. The method of claim 13 further comprising, before the step of receiving information from the portable communication device, the step of sending challenge information to the portable communication device in response to receiving the operational information.

16. The method of claim 15 wherein the step of determining whether the information received is authentic information comprises the step of determining whether the information received is authentic information in response to the challenge information sent thereto and the information received therefrom.

17. The method of claim 13 further comprising the step of determining whether subsidy lock information stored in a subscriber identity module coupled to the wireless communication module corresponds to correct subsidy lock information, and wherein the step of the wireless communication module operating as a wireless communication device in the communication system comprises the step of the wireless communication module operating as a wireless communication device in the communication system in response to the information received being authentic information and the subsidy lock information corresponding to correct subsidy lock information.

18. The method of claim 17 wherein the step of determining whether subsidy lock information corresponds to correct subsidy lock information comprises the step of determining whether subsidy lock information stored in the subscriber identity module is equivalent to public land mobile network (PLMN) information designating a PLMN communication system, and wherein the step of the wireless communication module operating as a wireless communication device comprises the step of the wireless communication module operating as a wireless communication device in the PLMN communication system in response to the information received being authentic information and the subsidy lock information being equivalent to the PLMN information.

19. A communication module comprising:
a coupler for physically and electrically coupling the communication module to a portable communication device; and
a module controller coupled to the coupler for receiving signals from the portable communication device and for providing signals thereto, the module controller detecting operable information from the user interface devices setting a state thereof as operable and, thereafter, determining whether information received from the portable communication device is authentic, and wherein the module controller operates the communication module together with the portable communication device as a wireless communication device in response to the information from the portable communication device being authentic.

20. The communication module of claim 19 further comprising user interface devices, and wherein the module controller detects operable information from the user interface devices setting a state thereof as operable and, thereafter, determines whether information received from the portable communication device is authentic.

21. The communication module of claim 19 wherein the coupler couples the communication module to a portable communication device having user interface devices, and wherein the module controller detects operable information from the user interface devices setting a state thereof as operable and, thereafter, determines whether information received from the portable communication device is authentic.

22. The communication module of claim 19 wherein the module controller is coupled to a subscriber identity module having a storage device for storing subsidy lock information and wherein the module controller operates the portable communication device as a wireless communication device in response to the information from the portable communication device being authentic and the subsidy lock information corresponding to correct subsidy lock information.

23. The communication module of claim 19 wherein the module controller comprises a baseband controller for demodulating and decoding signals received by the wireless communication device to recover information and providing the information to the coupler for provision to the portable communication device, the baseband controller further coupled to the coupler for receiving information from the portable communication device and for encoding and modulating the received information into signals to be transmitted from the wireless communication device.

24. A method for checking subsidy lock in a wireless communication device capable of operating in a communication system, the wireless communication device comprising a first module, a second module and a subscriber identity module coupled to the first and second modules, the method comprising the steps of:
the first module determining whether subsidy lock information stored in the subscriber identity module corresponds to correct subsidy lock information;
the second module determining whether the subsidy lock information stored in the subscriber identity module corresponds to the correct subsidy lock information; and
setting a state of the wireless communication device as operable in the communication system in response to the first module and the second module both determining that the subsidy lock information stored in the subscriber identity module corresponds to the correct subsidy lock information.

25. The method of claim 24 wherein the step of setting the state of the wireless communication device as operable comprises the steps of:
the first module receiving information from the second module;
the first module determining whether the information received from the second module is authentic information; and
setting a state of the wireless communication device as operable in the communication system in response to the first module and the second module both determining that the subsidy lock information stored in the subscriber identity module corresponds to the correct subsidy lock information and the first module determining that information received from the second module is authentic information.

26. The method of claim 24 wherein the step of setting the state of the wireless communication device as operable comprises the steps of:
the second module receiving information from the first module;
the second module determining whether the information received from the first module is authentic information; and
setting a state of the wireless communication device as operable in the communication system in response to the first module and the second module both determining that the subsidy lock information stored in the subscriber identity module corresponds to the correct subsidy lock information and the second module determining that information received from the first module is authentic information.

27. The method of claim 25 wherein the step of setting the state of the wireless communication device as operable comprises the steps of:
the second module receiving information from the first module;
the second module determining whether the information received from the first module is authentic information; and
setting a state of the wireless communication device as operable in the communication system in response to the first module and the second module both determining that the subsidy lock information stored in the subscriber identity module corresponds to the correct subsidy lock information and the first module and the second module determining that information received from the second module and the first module, respectively, are both authentic information.

28. A wireless communication device capable of operating in a communication system, the wireless communication device comprising:
a subscriber identity module comprising a storage device for storing subsidy lock information;
a first module coupled to the subscriber identity module, the first module comprising:
a first coupler for physically and electrically coupling the first module to a second module; and
a first module controller for controlling the operation of the first module and coupled to the subscriber identity module for determining whether the subsidy lock information is correct subsidy lock information for the communication system, the first module controller also coupled to the first coupler for providing signals to the second module and for receiving signals therefrom, and wherein the first module controller generates a subsidy lock success signal in response to determining that the subsidy lock information is correct subsidy lock information for the communication system and provides the subsidy lock success signal to the first coupler for provision to the second module; and
the second module coupled to the subscriber identity module, the second module comprising:
a second coupler for physically and electrically coupling the second module to a first module; and
a second module controller for controlling the operation of the second module and coupled to the subscriber identity module for determining whether the subsidy lock information is correct subsidy lock information for the communication system, the second module controller coupled to the second coupler for providing signals to the first module and for receiving signals therefrom, and wherein the second module controller sets a state of the wireless communication device as operable in the communication system in response to determining that the subsidy lock information is correct subsidy lock information for the communication system and receiving the subsidy lock success signal from the first controller.

29. The wireless communication device of claim 28 wherein the first module controller generates an authentication signal in response to determining whether identification information received from the second module controller is equivalent to authentic identification information and provides the authentication signal to the first coupler for provision to the second module.

30. The wireless communication device of claim 28 wherein the second module controller determines whether identification information received from the first module controller is equivalent to authentic identification information, the second module controller setting the state of the wireless communication device as operable in the communication system in response to (a) determining that the subsidy lock information is correct subsidy lock information for the communication system, (b) receiving the subsidy lock success signal from the first controller, and (c) determining that the identification information received from the first module controller is equivalent to authentic identification information.

31. The wireless communication device of claim 29 wherein the second module controller determines whether identification information received from the first module controller is equivalent to authentic identification information, the second module controller setting the state of the wireless communication device as operable in the communication system in response to (a) determining that the subsidy lock information is correct subsidy lock information for the communication system, (b) receiving the subsidy lock success signal from the first controller, (c) determining that the identification information received from the first module controller is equivalent to authentic identification information, and (d) receiving the authentication signal indicating that the first module controller has determined that identification information received from the second module controller is equivalent to authentic identification information.

32. The wireless communication device of claim 28 wherein the second module is a portable communication handset.

33. The wireless communication device of claim 32 wherein the portable communication handset comprises user interface devices comprising a telephonic numeric keypad for receiving user input for controlling operation of the wireless communication device and wherein the second module controller comprises a user interface controller.

34. The wireless communication device of claim 33 wherein the user interface devices further comprise a display for displaying information to a user, and wherein the user interface controller comprises a display driver.

35. The wireless communication device of claim 28 wherein the first module is a wireless communication modem and where in the first module controller comprises a baseband controller for demodulating and decoding signals received by the wireless communication device to recover information and providing the information to the first coupler for provision to the second module, the baseband controller further coupled to the first coupler for receiving information from the second module and for encoding and modulating the received information into signals to be transmitted from the wireless communication device.
